(19) United States
(12) Patent Application Publication
(10) Pub. No.: US 2025/0079028 A1
(43) Pub. Date: Mar. 6, 2025

(54) REFUELLING OF A NUCLEAR REACTOR

(71) Applicant: Rolls-Royce SMR Limited, Derby, Derbyshire (GB)

(72) Inventor: Daniel ROBERTSON, Derby, Derbyshire (GB)

(21) Appl. No.: 18/554,395

(22) PCT Filed: Apr. 14, 2022
(86) PCT No.: PCT/GB2022/050959

§ 371 Date: Oct. 6, 2023

(30) Foreign Application Priority Data
Apr. 19, 2021 (GB) 2105552.0

(51) Int. Cl. G21C 19/20; B25J 13/08; G21C 19/105

(52) U.S. Cl. CPC G21C 19/205; B25J 13/088; G21C 19/105

(57) ABSTRACT

A robotic arm for handling fuel in a nuclear reactor is provided, the robotic arm comprising a movement mechanism for moving the robotic arm along an x-axis. The movement mechanism can be coupled to an arm portion whose centre line is parallel with the x-axis, a grab head portion which is pivotally mounted to the arm portion. The grab head can be rotated vertically to be parallel to a z-axis, and have a telescopic portion that allows the grab head to extend along the z-axis and a grip mechanism at its distal end for gripping fuel assemblies of the nuclear reactor.

This application claims priority from GB 2105552.0 filed 19 Apr. 2021, the contents and elements of which are herein incorporated by reference for all purposes

### FIELD OF THE DISCLOSURE

The present disclosure relates to refuelling a nuclear reactor. In particular, it relates to a robotic arm for use in a refuelling process of a nuclear reactor.

### BACKGROUND OF THE DISCLOSURE

Nuclear power plants convert heat energy from the nuclear fission of fissile material contained in fuel assemblies into electrical energy. Pressurised water reactor (PWR) nuclear power plants have a primary coolant circuit which typically connects the following pressurised components: a reactor pressure vessel (RPV) containing the fuel assemblies; one or more steam generators; and a pressuriser. Coolant pumps in the primary circuit circulate pressurised water through pipework between these components. The RPV houses the nuclear core which heats the water in the primary circuit. The steam generator functions as a heat exchanger between the primary circuit and a secondary system where steam is generated to power turbines. Boiling Water Reactors (BWR) operate in a similar way to a PWR except that rather than using high pressure circuits to maintain the water in its liquid states, BWRs use the core to heat the water to turn it into steam to drive the steam generators.

Such reactors require refuelling at intervals of typically 18-24 months. During this refuelling the reactor is powered down and the head of the reactor pressure vessel is removed. The PWR or BWR plant will be depressurised to equalise pressure to that of the atmosphere within the containment building, and where necessary the water in the primary loop will be drained to a level just below that of the head of the reactor. FIG. 1 presents an example of a prior art reactor with associated refuelling equipment 10. In this the reactor uses a water filled refuelling cavity 11, with the head of the reactor pressure vessel 13 sitting in the cavity and designed to hold a volume of water. The reactor is housed within a containment structure having walls 12. In order to allow for refuelling the head of the reactor is unbolted and lifted to another location (not shown), which does not interfere with refuelling operations. The cavity above the reactor head is filled with water of the same quality as the primary circuit to provide shielding from gamma radiation. Some of the fuel is then removed and replaced with fresh fuel rods, whilst other fuel rods may be repositioned within the reactor pressure vessel. The spent fuel is typically lifted by remote handling techniques. Typically, in the fuel route a fuel rod or assembly 16 is lifted out of the reactor pressure vessel using an overhead travelling crane 14. Once above the reactor pressure vessel it is translated horizontally using the overhead travelling crane and deposited in a turnover rig 15 which rotates the spent fuel rod into the horizontal position. The turnover rig moves the fuel out of containment via a flooded tunnel.

One type of PWR reactor, is a so called close coupled PWR in which the reactor pressure vessel and the steam generators are connected by shot sections of pipe without any structure in between. This arrangement makes conventional refuelling methods to be either impossible or much more complex and difficult. Alternatively, they can affect the design considerations for the plant, in particular it can add limitations to the degree to which the plant may be close coupled. As such there is a need for an alternative method and configuration to enable refuelling of the reactor.

### SUMMARY OF THE DISCLOSURE

According to a first aspect there is provided a robotic arm for handling fuel in a nuclear reactor, the robotic arm comprising a movement mechanism for moving the robotic arm along an x-axis, the movement mechanism being coupled to an arm portion whose centre line is parallel with the x-axis, a grab head portion which is pivotally mounted to the arm portion such that the grab head can be rotated vertically to be parallel to a z-axis, wherein the grab head further comprises a telescopic portion that allows the grab head to extend along the z-axis and a grip mechanism at its distal end for gripping fuel assemblies of the nuclear reactor.

The grab head may be mounted to the arm portion using a pantograph head that allows the grab head to move along a y-axis.

The movement mechanism may be controlled by an electric motor.

The electric motor may be a stepper motor.

The positioning of the robotic arm may be controlled using encoder signals to control any movement of the robotic arm.

The movement mechanism may comprise a rail system.

A nuclear reactor containment structure comprising a robotic arm according to the aspects described above.

According to a second aspect there is provided a method of removing fuel assemblies from a nuclear reactor using a robotic arm, wherein the method comprises:
1) extending the robotic arm along the x-axis into a containment structure of a nuclear reactor using a movement mechanism,
2) rotating a grab head of the robotic arm, such that the grab head is rotated to the z-axis which is vertically offset to the x-axis.
3) extending the grab head towards a fuel assembly in a nuclear reactor core,
4) using a grip mechanism mounted at the distal end of grab head to grip the fuel assembly,
5) retracting the grab head to lift the fuel assembly out of the reactor core,
6) withdrawing the robotic arm to a fuel storage location,
7) extending the grab head to lower the fuel assembly into the fuel storage location and releasing the grip mechanism to release the fuel assembly.

After retracting the grab head, the grab head may be rotated to return to be parallel to the x-axis.

The grab head may be able to move in the y axis before the grab head is extended through the movement of a pantograph head portion.

A hatch may be opened in the containment structure prior to extending the robotic arm.

After the fuel assembly has been released into storage, the grab head may be rotated to be parallel and the robotic arm is withdrawn through the hatch in the containment structure and the hatch is closed.

The movement of the robotic arm may be controlled by encoders sending position information to a robotic arm controller, which uses the information to control the extent of movement applied by electric motors mounted to the robotic arm.

Optional features of aspects will now be set out. These are applicable singly or in any combination.

The present invention may comprise or be comprised as part of a nuclear reactor power plant (referred to herein as a nuclear reactor). The present disclosure may relate to a Pressurized Water Reactor. Alternatively, it may relate to a Boiling Water Reactor. The nuclear reactor power plant may have a power output between 250 and 600 MW or between 300 and 550 MW.

The nuclear reactor power plant may be a modular reactor. A modular reactor may be considered as a reactor comprised of a number of modules that are manufactured off site (e.g. in a factory) and then the modules are assembled into a nuclear reactor power plant on site by connecting the modules together. Any of the primary, secondary and/or tertiary circuits may be formed in a modular construction.

The nuclear reactor of the present disclosure may comprise a primary circuit comprising a reactor pressure vessel; one or more steam generators and one or more pressurizer. The primary circuit circulates a medium (e.g. water) through the reactor pressure vessel to extract heat generated by nuclear fission in the core, the heat is then to delivered to the steam generators and transferred to the secondary circuit. The primary circuit may comprise between one and six steam generators; or between two and four steam generators; or may comprise three steam generators; or a range of any of the aforesaid numerical values. The primary circuit may comprise one; two; or more than two pressurizers. The primary circuit may comprise a circuit extending from the reactor pressure vessel to each of the steam generators, the circuits may carry hot medium to the steam generator from the reactor pressure vessel, and carry cooled medium from the steam generators back to the reactor pressure vessel. The medium may be circulated by one or more pumps. In some embodiments, the primary circuit may comprise one or two pumps per steam generator in the primary circuit.

In some embodiments, the medium circulated in the primary circuit may comprise water. In some embodiments, the medium may comprise a neutron absorbing substance added to the medium (e.g., boron, gadolinium). In some embodiments the pressure in the primary circuit may be at least 50, 80 100 or 150 bar during full power operations, and pressure may reach 80, 100, 150 or 180 bar during full power operations. In some embodiments, where water is the medium of the primary circuit, the heated water temperature of water leaving the reactor pressure vessel may be between 540 and 670 K, or between 560 and 650 K, or between 580 and 630 K during full power operations. In some embodiments, where water is the medium of the primary circuit, the cooled water temperature of water returning to the reactor pressure vessel may be between 510 and 600 K, or between 530 and 580 K during full power operations.

The nuclear reactor of the present disclosure may comprise a secondary circuit comprising circulating loops of water which extract heat from the primary circuit in the steam generators to convert water to steam to drive turbines. In embodiments, the secondary loop may comprise one or two high pressure turbines and one or two low pressure turbines.

The secondary circuit may comprise a heat exchanger to condense steam to water as it is returned to the steam generator. The heat exchanger may be connected to a tertiary loop which may comprise a large body of water to act as a heat sink.

The reactor vessel may comprise a steel pressure vessel, the pressure vessel may be from 5 to 15 m high, or from 9.5 to 11.5 m high and the diameter may be between 2 and 7 m, or between 3 and 6 m, or between 4 to 5 m. The pressure vessel may comprise a reactor body and a reactor head positioned vertically above the reactor body. The reactor head may be connected to the reactor body by a series of studs that pass through a flange on the reactor head and a corresponding flange on the reactor body.

The reactor head may comprise an integrated head assembly in which a number of elements of the reactor structure may be consolidated into a single element. Included among the consolidated elements are a pressure vessel head, a cooling shroud, control rod drive mechanisms, a missile shield, a lifting rig, a hoist assembly, and a cable tray assembly.

The nuclear core may be comprised of a number of fuel assemblies, with the fuel assemblies containing fuel rods. The fuel rods may be formed of pellets of fissile material. The fuel assemblies may also include space for control rods. For example, the fuel assembly may provide a housing for a 17×17 grid of rods i.e. 289 total spaces. Of these 289 total spaces, 24 may be reserved for the control rods for the reactor, each of which may be formed of 24 control rodlets connected to a main arm, and one may be reserved for an instrumentation tube. The control rods are movable in and out of the core to provide control of the fission process undergone by the fuel, by absorbing neutrons released during nuclear fission. The reactor core may comprise between 100-300 fuel assemblies. Fully inserting the control rods may typically lead to a subcritical state in which the reactor is shutdown. Up to 100% of fuel assemblies in the reactor core may contain control rods.

Movement of the control rod may be moved by a control rod drive mechanism. The control rod drive mechanism may command and power actuators to lower and raise the control rods in and out of the fuel assembly, and to hold the position of the control rods relative to the core. The control rod drive mechanism rods may be able to rapidly insert the control rods to quickly shut down (i.e. scram) the reactor.

The primary circuit may be housed within a containment structure to retain steam from the primary circuit in the event of an accident. The containment may be between 15 and 60 m in diameter, or between 30 and 50 m in diameter. The containment structure may be formed from steel or concrete, or concrete lined with steel. The containment may house one or more lifting devices (e.g. a polar crane). The lifting device may be housed in the top of the containment above the reactor pressure vessel. The containment may contain within or support exterior to, a water tank for emergency cooling of the reactor. The containment may contain equipment and facilities to allow for refuelling of the reactor, for the storage of fuel assemblies and transportation of fuel assemblies between the inside and outside of the containment.

The power plant may contain one or more civil structures to protect reactor elements from external hazards (e.g. missile strike) and natural hazards (e.g. tsunami). The civil structures may be made from steel, or concrete, or a combination of both.

### BRIEF DISCUSSION OF THE FIGURES

Embodiments will now be described by way of example only, with reference to the Figures, in which:

FIG. 1 is a schematic diagram of a prior art refuelling method;

FIG. 2 is a schematic diagram of a PWR;

FIG. 3 shows a cross-section of the robotic arm within the containment structure in a not in use position;

FIG. 4 shows a cross section of the robotic are within the containment structure extended and in use;

FIG. 5 shows a plan view of a pantograph head; and FIG. 6 shows a cutaway schematic of the robotic arm positioned within a containment structure.

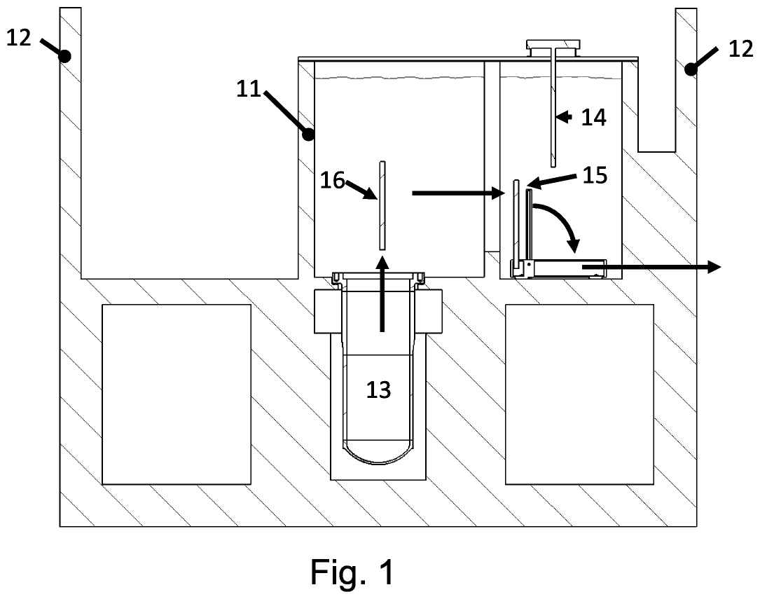

### DETAILED DESCRIPTION OF THE DISCLOSURE

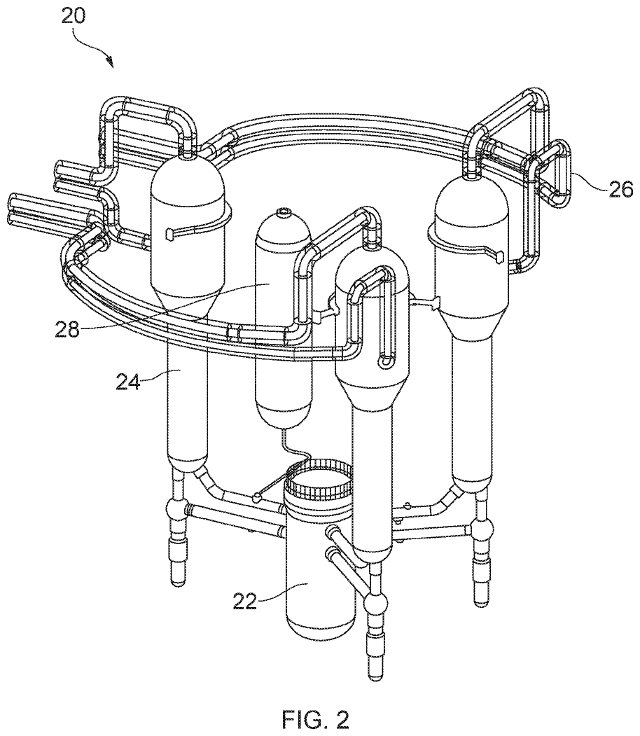

FIG. 2 is a schematic diagram of a PWR 20. An RPV 22 containing fuel assemblies is centrally located in the reactor. Clustered around the RPV are three steam generators 24 connected to the RPV by pipework 26 of the pressurised water, primary coolant circuit. Coolant pumps circulate pressurised water around the primary coolant circuit, taking heated water from the RPV to the steam generators, and cooled water from the steam generators to the RPV.

A pressuriser 28 maintains the water pressure in the primary coolant circuit at about 155 bar. In the steam generators 24, heat is transferred from the pressurised water to feed water circulating in pipework 26 of a secondary coolant circuit, thereby producing steam which is used to drive turbines which in turn drive an electricity-generator. The steam is then condensed before returning to the steam generators.

Prior to refuelling the containment structure is flooded to improve the gamma ray shielding. This is carried out by adding water to the containment that is the of the same type as that used in the primary circuit. With the containment flooded the head of the reactor pressure vessel can be lifted to provide access for the refuelling machine. The head lift may be done using a crane, hoist, jacks or any other suitable technique that would be apparent to the person skilled in the art.

Prior art refuelling methods typically involve the use of a crane—as discussed above-which is suitable in large power plants. However, as there is a growing desire to develop smaller plants with more modular reactor designs; this work is leading to designs in which the amount of operating space around the reactor for such equipment is reduced. In particular, the work being carried out on close-coupled reactors in which the steam generators are separated form the reactor pressure vessel by short sections of pipe makes the use of overhead cranes challenging if not impossible. Furthermore, the use of a crane also requires space for the use of a turnover rig so that the spent fuel assemblies can be moved out of the containment structure. Each of these pieces of equipment increases the size and complexity of the containment structure and makes it difficult to use such methods in a modular construction. Consequently, it is desirable to produce a system that eliminates the need for the turnover rig.

Furthermore, by moving away from these designs the design space of the containment structure is no longer limited by the requirements for these two components.

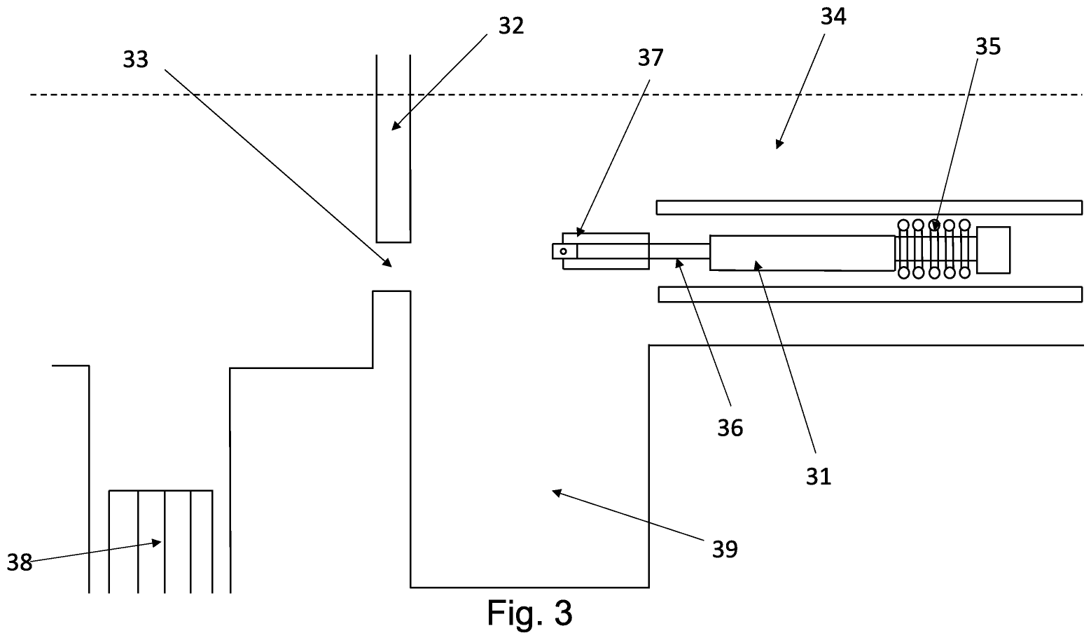

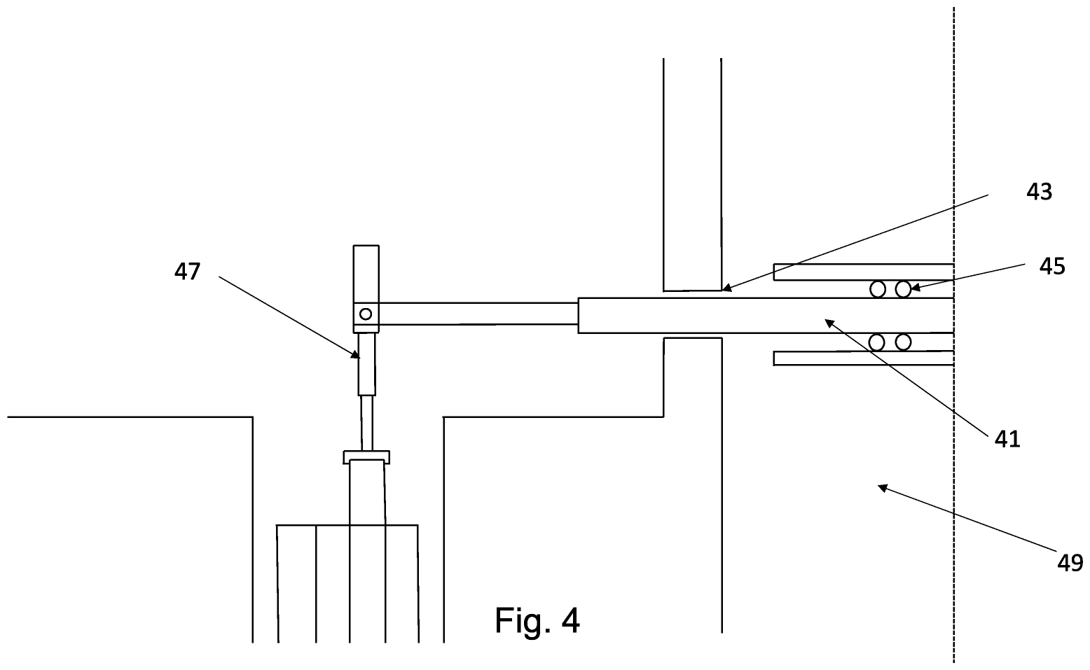

Instead of the use of a crane a robotic arm may be deployed instead for controlled refuelling of the reactor. A robotic arm for refuelling is presented in FIG. 3. The robotic arm 31 may be housed outside of the containment structure 32. By placing the device outside of the containment; thus, allowing for easier maintenance, testing and inspection of the arm whilst it is not in use. As a result of this the reliability of the device is increased. Access into the containment may be provided by the use of a suitable hatch 33. The hatch may be opened manually or automatically. The chamber 34 housing the robotic arm and the containment may be in fluid communication with the reactor such that when the refuelling takes place the containment can be flooded for protection against the radiation emitted by the core and the fuel rods. The robotic arm is disposed on a moving mechanism 35. This mechanism may be a set of wheels. Alternatively, this could be the use of rails. Any other suitable movement mechanism may be used as would be apparent to the person skilled in the art. The movement mechanism may be controlled by an electric motor. In particular, this may be a stepper motor. The movement mechanism may be connected to a housing that surrounds the arm. In this case, the arm housing acts as a support and protection for the workings of the robotic arm. Alternatively, the movement mechanism may be connected directly to robotic arm.

The robotic arm consists of an arm portion 36 that extends in an x-axis, which is parallel to the body of the arm. The arm portion may have a telescopic section. Alternatively, it may be a single rigid body. The end of the of the arm portion has a pivot to which a grab arm 37 is connected. The pivot allows the grab arm to rotate from its movement position on the x-axis to a grab position in the z axis, which is vertically offset relative to the horizontal x-axis of the arm. The grab arm consists of a telescopic portion that allows the arm to extend towards the fuel assemblies when the arm is in position. The rotation of the grab arm relative to the arm portion may be carried out by an electric motor. In particular, this may be performed by a stepper motor. Similarly, the control of the telescopic arm mechanism may be controlled by an electric motor. Alternatively, it may be controlled by any other suitable means that would be apparent to the person skilled in the art, such as hydraulic control. The end of the grab arm has a gripping mechanism. The grab head may be connected to the robotic arm using a pantograph arm, which will allow the head to move in the y-axis which lies in the same horizontal plane as the x-axis. Such a mechanism will allow the arm to be positioned above any of the fuel assemblies within the array. Thus, by the movement of the arm in the x-direction, and the movement of the grab arm in the y-axis and the downward motion of the grab arm allows the robotic arm to access all of the fuel assemblies 38. Therefore, using such a method allows for all the fuel assemblies to be remove and replaced. The exact positioning of the arm may be controlled by the use of any suitable means, as would be apparent to the person skilled in the art. This for example may be through the use of encoders. These may be used to determine the distance and position of the arm and grab head relative to other features of the reactor, and the information from this may be used to control stepper or electric motors to position the arm and grab head. In the event of a failure of the grab arm, the grab arm may be equipped with a fail close ratchet system which will maintain the position of the grab arm.

The grab arm may then be wound up to the horizontal position using external tools. Due to the position of other equipment in the containment structure and around the reactor the grab arm may be required to have its telescopic component retracted and the grab arm rotated into the horizontal position, which is to say that it lies along the x-axis. A fail close pin may be used to hold the grab arm in the horizontal position.

It is possible to operate a plurality of robotic arms during the same refuelling procedure. These can be operated form different sides of the reactor; however, this has the limitation that the reactor requires more than one fuel pool. Alternatively, the arms could be operated from the same side of the reactor as each other. For example, they could be positioned next to each other or with one or more vertically above or below the others. The robotic arms could work on the whole of the core together. Alternatively, they could work on opposite portions or halves of the core to each other. In this way the different arms would not interact.

The removed fuel may be removed and deposited in a fuel handling pool 39. The fuel handling pool can be positioned adjacent to the robotic arm housing. The fuel can be manipulated such that it can be positioned in any appropriate orientation. For example, this could be vertical or horizontal. The fuel could also be deposited into a rack within the refuelling pool. The rack could be either used as a buffer for fuel storage during the refuelling operation or as a medium-term fuel storage solution during plant operation. The spent fuel pool may be located inside or outside of the containment structure that houses the reactor. Alternatively, it may be positioned in a separate structure adjacent to the containment and to the housing for the arm structure.

Alternatively, the fuel could be loaded into a fuel carriage for transportation to a fuel pool. This may occur in the containment structure. Alternatively, it may occur in a space outside the containment structure. The fuel carriage which is then used to extract the fuel can moved in either a horizontal or vertical direction.

An embodiment of the method of using the robotic arm is shown in FIG. 4. When the reactor is required to be refuelled the robotic arm 41 can be operated. The reactor is powered down and the containment is flooded with water. Once the containment has been flooded it is safe for the reactor pressure vessel head to be disconnected and removed using a crane or hoist. With the reactor pressure vessel head removed the robotic arm can be operated as part of the refuelling process. The containment can be opened by the movement of hatch 43 into the containment; this will allow access for the robotic arm into the containment structure. The robotic arm can then be moved along the x-axis which lies parallel to the robotic arm. The movement of the robotic arm is carried out through controlled use of the movement mechanism 45. This controls the extent to which the arm is moved into the containment structure. A barrier may be used to prevent the arm penetrating the containment structure more than intended. Once the arm is positioned within the containment with the grab head positioned above the reactor core, the grab head can be rotated such that it moves from a horizontal position to a vertical position, i.e. so that it lies along the z-axis rather than the x-axis. A pantograph arm at the end of the robotic arm may be used to move the grab head along the y-axis as well as the x-axis. The grab head is then extended to move along the z-axis towards the fuel assemblies. With the grab head in position the grab head may be operated to grab the fuel assemblies using the grip mechanism mounted to the grab head. The fuel rod is then extracted by retracting the grab head back along the z-axis. The grab head may then be rotated so that it and the fuel rod and grab arm are rotated back to being parallel to the x-axis. The arm is then retracted away from the reactor core. With the arm moved away from the reactor core the fuel can be placed in a fuel carriage for transport to a fuel storage pool or may be deposited directly into a fuel handling pool. A similar, but reverse process may be used to load the new fuel rods into the reactor. The position of the arm and the grab head may be determined using encoders. The movement of the different arm the grab head may be controlled by electric motors. In particular these may be stepper motors.

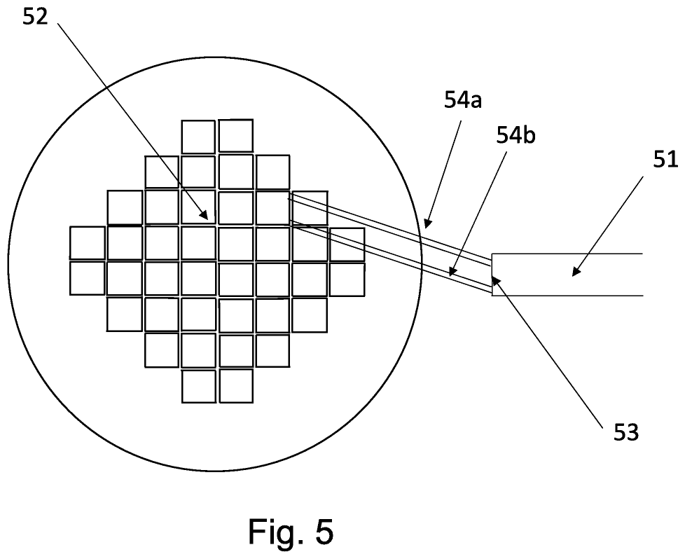

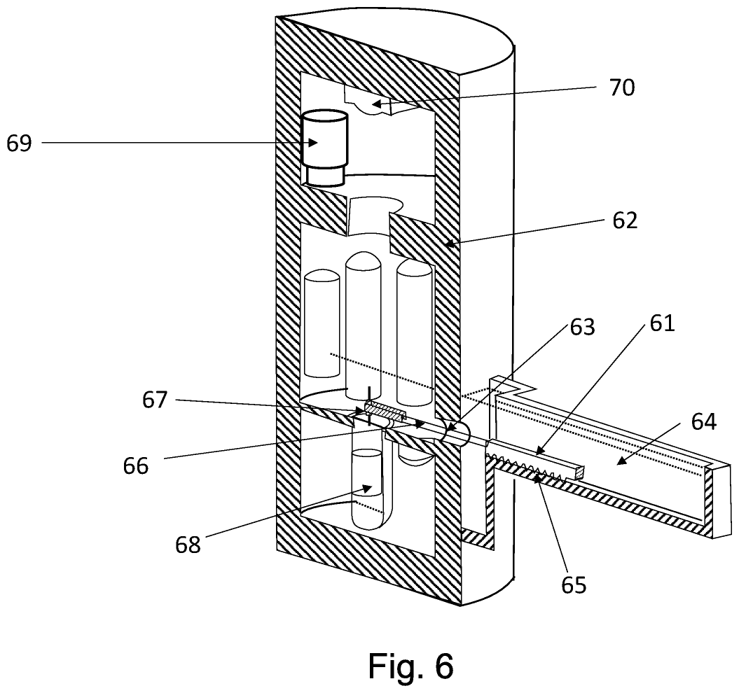

FIG. 5 shows an example of a pantograph arm that may be used to connect the robotic arm to the grab head 51. In this the robotic arm extends along the x-axis and connects to the pantograph arm 53. The pantograph arm allows the position of the grab head to be able to be varied along the y-axis. This it can allow the grab head to access any of the fuel assemblies 52 within the core. In this example the head is shown having two arms 54a and 54b, which keep the grab head oriented int the x-y plane. The x-axis motion being controlled by the robotic arm and the movement mechanism.

An example of a robotic arm positioned relative to the containment is presented in FIG. 6. The robotic arm 61 is be housed outside of the containment structure 62. Access into the containment is be provided by the use of a suitable hatch 63. The chamber 64 housing the robotic arm and the containment are in fluid communication with the reactor such that when the refuelling takes place the containment can be flooded for protection against the radiation emitted by the core and the fuel rods. The robotic arm is disposed on a moving mechanism 65. The movement mechanism, which is this example is a track, is connected to a housing that surrounds the arm. In this case, the arm housing acts as a support and protection for the workings of the robotic arm.

The robotic arm consists of an arm portion 66 that extends in an x-axis, which is parallel to the body of the arm. The end of the of the arm portion has a pivot to which a grab arm 67 is connected. The pivot allows the grab arm to rotate from its movement position on the x-axis to a grab position in the z axis, which is vertically offset relative to the horizontal x-axis of the arm. The grab arm consists of a telescopic portion that allows the arm to extend towards the fuel assemblies when the am is in position. The end of the grab arm has a gripping mechanism. The grab head may be connected to the robotic arm using a pantograph arm, which will allow the head to move in the y-axis which lies in the same horizontal plane as the x-axis. Thus, by the movement of the arm in the x-direction, and the movement of the grab arm in the y-axis and the downward motion of the grab arm allows the robotic arm to access the fuel assemblies 68. Prior to refuelling the containment structure is flooded to improve the gamma ray shielding. With the containment flooded the head of the reactor pressure vessel 69 can be lifted to provide access for the refuelling machine. The head lift is done using a crane 70.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention. The movement of the arm into the containment structure may be in a two-stage process, such that the arm is moved in a first stage to a general position, whilst in the second stage the arm is moved in a slower and more controlled way up to reactor such that it is accurately positioned above the reactor.

1. A robotic arm for handling fuel in a nuclear reactor, the robotic arm comprising a movement mechanism for moving the robotic arm along an x-axis, the movement mechanism being coupled to an arm portion whose centre line is parallel with the x-axis, a grab head portion which is pivotally mounted to the arm portion such that the grab head can be rotated vertically to be parallel to a z-axis, wherein the grab head further comprises a telescopic portion that allows the grab head to extend along the z-axis and a grip mechanism at its distal end for gripping fuel assemblies of the nuclear reactor.

2. The robotic arm of claim 1, wherein the grab head is mounted to the arm portion using a pantograph head that allows the grab head to move along a y-axis.

3. The robotic arm of claim 1, wherein the movement mechanism is controlled by an electric motor.

4. The robotic arm of claim 3, wherein the electric motor is a stepper motor.

5. The robotic arm of claim 1, wherein the positioning of the robotic arm is controlled using encoder signals to control any movement of the robotic arm.

6. The robotic arm of claim 1, wherein the movement mechanism comprises a rail system.

7. A nuclear reactor containment structure comprising a robotic arm according claim 1.

8. A method of removing fuel assemblies from a nuclear reactor using a robotic arm, wherein the method comprises:
1. extending the robotic arm along the x-axis into a containment structure of a nuclear reactor using a movement mechanism,
2. rotating a grab head of the robotic arm, such that the grab head is rotated to the z-axis which is vertically offset to the x-axis.
3. extending the grab head towards a fuel assembly in a nuclear reactor core,
4. using a grip mechanism mounted at the distal end of grab head to grip the fuel assembly,
5. retracting the grab head to lift the fuel assembly out of the reactor core,
6. withdrawing the robotic arm to a fuel storage location,
7. extending the grab head to lower the fuel assembly into the fuel storage location and releasing the grip mechanism to release the fuel assembly.

9. The method of claim 8, wherein after retracting the grab head, the grab head is rotated to return to be parallel to the x-axis.

10. The method of claim 8, wherein the grab head is able to move in the y axis before the grab head is extended through the movement of a pantograph head portion.

11. The method of claim 8, wherein a hatch is opened in the containment structure prior to extending the robotic arm.

12. The method of claim 11, wherein after the fuel assembly has been released into storage, the grab head is rotated to be parallel and the robotic arm is withdrawn through the hatch in the containment structure and the hatch is closed.

13. The method of claim 8, wherein the movement of the robotic arm is controlled by encoders sending position information to a robotic arm controller, which uses the information to control the extent of movement applied by electric motors mounted to the robotic arm.
